(19) United States
(12) Patent Application Publication
(10) Pub. No.: US 2020/0130307 A1
(43) Pub. Date: Apr. 30, 2020

(54) METHOD OF PRODUCING PNEUMATIC TIRE AND HOUSING HOLDER OF BEAD MEMBER

(71) Applicant: Toyo Tire Corporation, Itami-shi (JP)

(72) Inventor: Norihiko Kodama, Itami-shi (JP)

(73) Assignee: Toyo Tire Corporation, Itami-shi (JP)

(21) Appl. No.: 16/573,375

(22) Filed: Sep. 17, 2019

(30) Foreign Application Priority Data
Oct. 26, 2018 (JP) 2018-202068

(51) Int. Cl. B29D 30/48; B29C 48/12; B29C 48/88

(52) U.S. Cl. CPC B29D 30/48; B29D 2030/481; B29C 48/911; B29C 48/12

(57) ABSTRACT

To suppress occurrence of curl at an edge part of a bead filler at the time of producing a pneumatic tire. A method of producing a pneumatic tire includes the steps of fabricating a bead member by integrating a bead filler formed by extrusion molding with a bead core in a state where a temperature difference between an edge part and a root part of the bead filler is 25° C. or less as well as a temperature at the edge part is 39° C. or more, cooling the bead member by being placed on a support surface supporting a side surface of the bead filler and forming a green tire using the cooled bead member.

### CROSS-REFERENCE TO RELATED APPLICATIONS

This application is based upon and claims the benefit of priority from the prior Japanese Patent Application No. 2018-202068, filed on Oct. 26, 2018; the entire contents of which are incorporated herein by reference.

### BACKGROUND OF THE INVENTION

### 1. Field of the Invention

An embodiment of the present invention relates to a method of producing a pneumatic tire. The embodiment also relates to a housing holder of a bead member used for production of the pneumatic tire.

### 2. Description of Related Art

In a pneumatic tire, an annular bead core and a bead filler are embedded in a bead part. In production of such pneumatic tire, when a bead member including the bead core and the bead filler is fabricated, both ends of the bead filler formed by extrusion molding having an approximately triangular shape in cross section are joined to form the bead member in an annular shape. After that, an edge side of the bead filler is allowed to stand while pressure-joining a root part on a thick wall side of the bead filler to an outer peripheral surface of the bead core. Accordingly, the bead member in which the bead filler having a cross-sectional shape narrowing in width toward the edge is integrated with the outer peripheral side of the bead core (for example, refer to JP-A-2015-058564 is fabricated.

In a molding process of a green tire using the bead member, the bead member is arranged at an outer periphery of a band body including a carcass ply, and an end part of the band body is turned up so as to wrap the bead member. There is a case where air intrusion failure occurs between a rubber member joined to the band body side and the bead filler at the time of turning up. In order to suppress such air intrusion failure, it can be considered that a height of the bead filler is increased so that a rubber amount of the rubber member joined to the band body side is shared with the bead filler side.

However, when the height of the bead filler is increased, an expanding amount at an edge part of the bead filler at the time of allowing the edge side of the bead filler to stand for integrating the bead filler with the bead core is increased in the fabrication process of the bead member. Accordingly, curl tends to occur at the edge part of the bead filler in the bead member, which causes troubles in the forming process of the green tire after that.

In JP-A-2004-043093, a housing holder capable of housing the bead member in a state of being placed on a horizontal support surface is disclosed. However, a fabrication process of the bead member is not described.

### SUMMARY OF THE INVENTION

An object to the embodiment of the present invention is to suppress curl of a bead filler in a bead member in a method of producing a pneumatic tire.

A method of producing a pneumatic tire according to an embodiment of the present invention is a method of producing a pneumatic tire including a bead core embedded in a bead part, and a bead filler arranged on an outer peripheral side of the bead core and having a cross-sectional shape narrowing in width toward an edge. The production method includes the steps of fabricating a bead member by integrating the bead filler formed by extrusion molding with the bead core in a state where a temperature difference between an edge part and a root part of the bead filler is 25° C. or less as well as a temperature at the edge part is 39° C. or more, cooling the bead member by being placed on a support surface supporting a side surface of the bead filler and forming a green tire using the cooled bead member.

A housing holder of a bead member according to an embodiment of the present invention is a housing holder for the bead member capable of being stacked vertically in a state of housing the bead member including a bead core and a bead filler integrated with the bead core on an outer peripheral side. The housing holder includes a disc-shaped placing part having a support surface capable of supporting a side surface of the bead filler, a plurality of convex parts provided on at least one of circumferences on an inner peripheral side or an outer peripheral side of the placing part and concave parts provided on back surface sides of the convex parts, to which convex parts of a housing holder to be a lower stage are capable of being fitted at the time of stacking the housing holders. Then, a gap capable of housing the bead member is formed between placing parts of housing holders of an upper stage and a lower stage by stacking plural housing holders so that the convex parts of the housing holder to be the upper stage and the convex parts of the housing holder to be the lower stage are shifted to one another in a circumferential direction, and the gap between placing parts of the housing holders of the upper stage and the lower stage becomes narrow by stacking the plural housing holders in a state where the convex parts are fitted to the concave parts so that the convex parts of the housing holder to be the upper stage and the convex parts of the housing holder to be the lower stage correspond to one another.

When adopting the method of producing the pneumatic tire according to the embodiment of the present invention, the bead filler formed by extrusion molding is integrated with the bead core before cooling in a state where the temperature difference between the edge part and the root part thereof is small, therefore, curl in the bead filler occurring just after fabrication of the bead member can be suppressed. Moreover, the fabricated bead member is cooled in the state of being placed on the support surface supporting the side surface of the bead filler, therefore, curl occurring at the time of cooling can be also suppressed. Accordingly, the green tire can be formed by using the bead member in which occurrence of curl in the bead filler is suppressed, and molding failure of the pneumatic tire can be suppressed.

### BRIEF DESCRIPTION OF THE DRAWINGS

FIG. 1 is a half-sectional view of a pneumatic tire according to an embodiment;

FIG. 2 is a cross-sectional view of a bead filler according to the embodiment;

FIG. 3 is a perspective view of a bead member according to the embodiment;

FIG. 4 is a cross-sectional view of the bead member;

FIG. 5 is a schematic view of a joining device showing a step before joining the bead filler:

FIG. 6 is a schematic view of the joining device showing a step after joining the bead filler;

FIG. 7 is a perspective view of a housing holder in a state where the bead member is placed;

FIG. 8 is a half-sectional view of housing holders stacked in a state where the bead members are housed;

FIG. 9 is a half-sectional view of housing holders stacked without housing the bead member, and

FIGS. 10A to 10C are views showing a forming process of a green tire.

### DESCRIPTION OF EMBODIMENTS

Hereinafter, an embodiment of the present invention will be explained with reference to the drawings.

A pneumatic tire according to an embodiment includes a pair of bead parts 10, a pair of sidewall parts 12 extending outward in a tire radial direction from the bead parts 10 and a tread part 14 provided between the pair of sidewall parts 12.

In each of the pair of bead parts 10, an annular bead core 16 and an annular bead filler 18 arranged on an outer peripheral side thereof are embedded, respectively. The bead core 16 is formed by a bundled body of steel wire and the like being covered with rubber, having an approximately hexagonal shape in cross section in this example. The bead filler 18 is made of hard rubber, which is a rubber member having a cross-sectional shape narrowing in width toward an edge.

A toroid-shaped carcass ply 20 is arranged between the pair of bead parts 10. The carcass ply 20 extends from the tread part 14 to the sidewall parts 12 and both end parts thereof are locked at the bead parts 10, which includes at least 1 ply. The carcass ply 20 is formed by a plurality of carcass codes arranged in parallel being covered with rubber. The both end parts of the carcass ply 20 are turned up from an inner side to an outer side of the bead cores 16 and the bead fillers 18 in the bead parts 10 and locked there.

A belt 22 including belt plies is provided on an outer peripheral side of the carcass ply 20 in the tread part 14 to reinforce the tread part 14, and a tread rubber 24 forming a ground contact surface is provided at an outer periphery of the belt 22. Side wall rubbers 26 are provided in the sidewall parts 12 on the outer side of the carcass ply 20. Rim strips 28 made of rubber are provided at portions contacting a rim in the bead parts 10. On an inner side of the carcass ply 20, an inner liner 30 for holding an air pressure is provided over the entire inner surface of the tire.

Next, a method of producing the pneumatic tire according to an embodiment will be explained. The method of producing the pneumatic tire according to the embodiment includes the following processes.

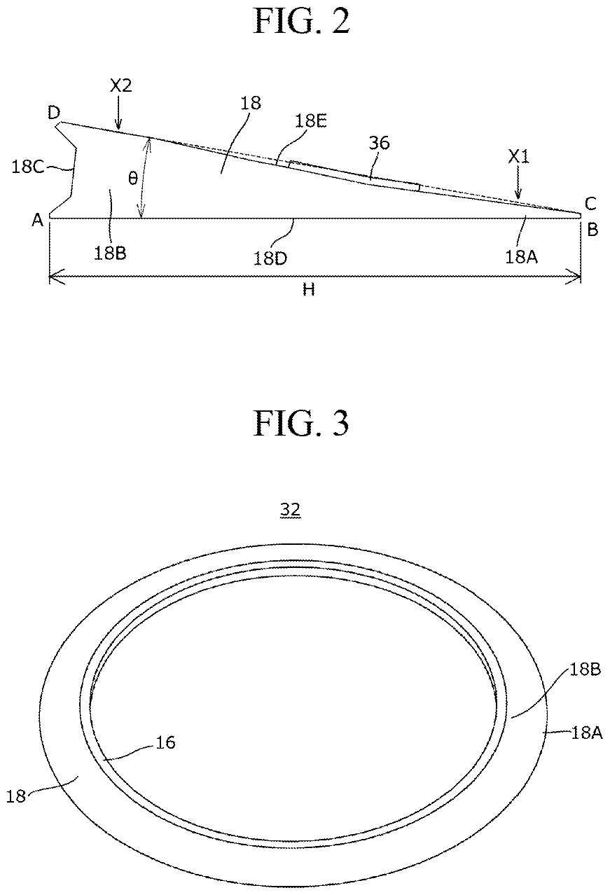

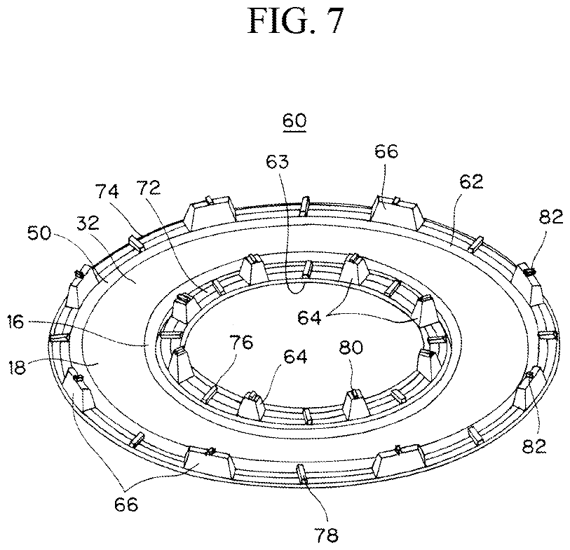

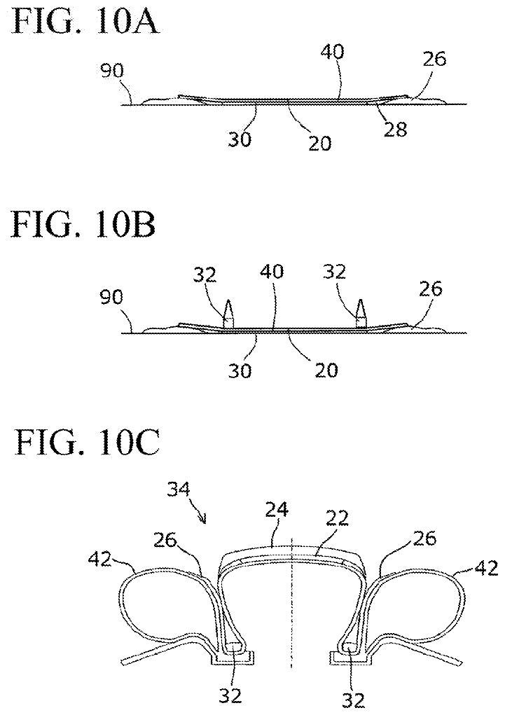

(1) A bead fabrication process (see FIG. 2 to FIG. 6) in which a bead member 32 is fabricated by integrating the bead filler 18 formed by extrusion molding with the bead core 16 in a state where a temperature difference between an edge part 18A and a root part 18B of the bead filler 18 is equal to or less than 25° C. and a temperature at the edge part 18A is equal to or more than 38° C.
(2) a bead cooling process (see FIG. 7 to FIG. 9) in which the bead member 32 is placed on a support surface 50 supporting a side surface 18D of the bead filler 18 and the bead member 32 is cooled, and
(2) a green tire forming process (see FIG. 10A to FIG. 10C) in which a green tire 34 is formed by using the cooled bead member 32.

First, the bead fabrication process will be explained.

FIG. 2 is a cross-sectional view showing an example of the bead filler 18 used in the bead fabrication process. The bead filler 18 is a rubber member having an approximately triangular shape in cross section, which can be fabricated by well-known extrusion molding and extruded from an extruder in a strip shape with a constant cross-sectional shape. The bead filler 18 formed of plural rubber parts and having the approximately triangular shape in cross section as a whole may be adopted though not shown.

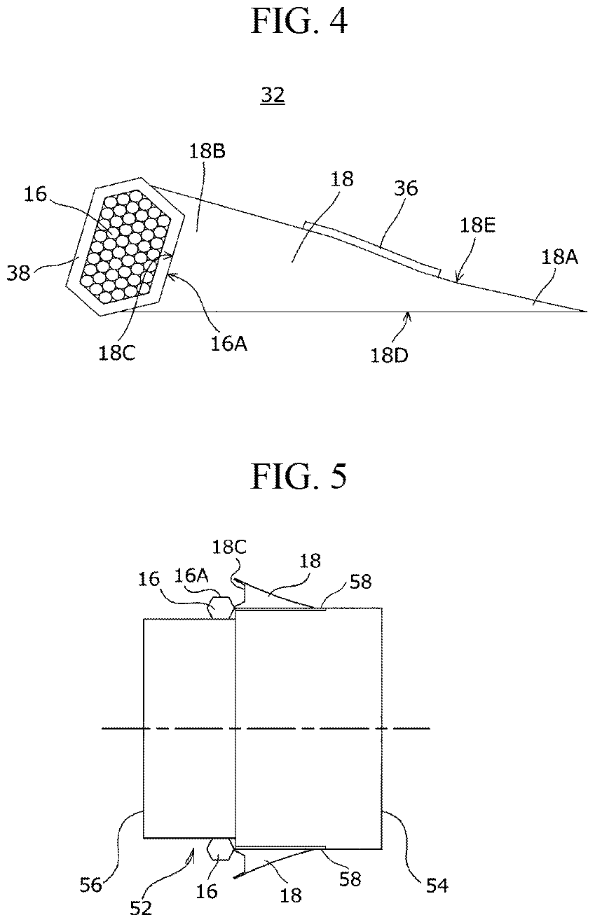

In this example, the bead filler 18 is formed so that a bottom surface 18C as a pressure-joining surface with respect to the bead core 16 has a concave shape corresponding to a shape of an outer peripheral surface 16A (see FIG. 4) of the bead core 16 having an approximately hexagonal shape in cross section.

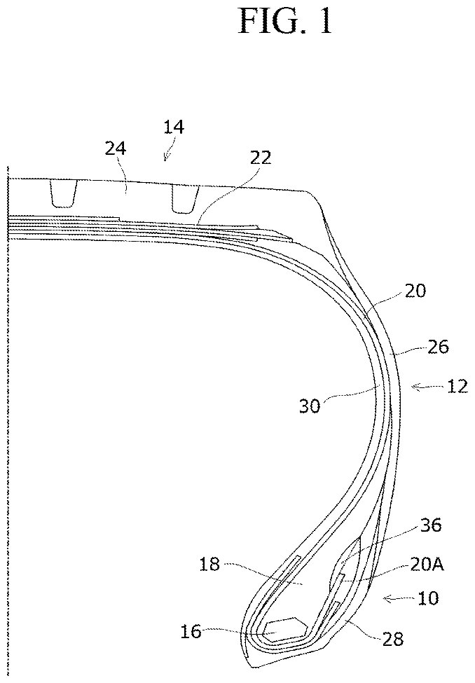

In the bead filler 18, one side surface 18D is flat, whereas the other side surface 18E has a slightly concave shape, and a reinforcing tape 36 made of rubber is stuck to the side surface 18E. The reinforcing tape 36 is provided at a position where a turnup end 20A of the carcass ply 20 contacts the bead filler 18 as shown in FIG. 1, which prevents damage of the bead filler 18 due to friction by the turnup end 20A.

A height H of the bead filler 18 formed by extrusion molding is not particularly limited, but preferably 80 mm or more. To use the bead filler 18 that is large in height is effective for suppressing air intrusion in the forming process of the green tire. The upper limit of the height H is not particularly limited, and for example, may be 120 mm or less. It is preferable that the height H of the bead filler 18 is set so that the edge (outer peripheral end) of the bead filler 18 is positioned downward from the tire maximum width position in the pneumatic tire. The tire maximum width position is a position where a dimension in a tire width direction is the maximum in a tire cross-sectional shape.

Here, the height H of the bead filler 18 is a distance from the root side joined to the bead core 16 to the edge as shown in FIG. 2, which is a width of the strip-shaped rubber part in a stage before being joined to the bead core 16.

An angle θ of the edge part 18A of the bead filler 18 formed by extrusion molding is not particularly limited, but preferably 16.0 degrees or less. When the bead filler 18 in which the angle of the edge part 18A is small is used, air intrusion in the edge part 18A of the bead filler 18 can be suppressed in the forming process of the green tire.

Here, the angle θ of the edge part 18A is an angle at an apex of a triangle in a cross-sectional shape shown in FIG. 2, which is an angle made by a line segment AB connecting the edge side to the root side in the side surface 18D and a line segment DC connecting the edge side to the root side in the side surface 18E.

In the bead fabrication process, the unvulcanized bead filler 18 extruded from the extruder is joined to the outer peripheral surface 16A of the bead core 16 to be integrated. Accordingly, the bead member 32 shown in FIG. 3 and FIG. 4 can be obtained. A reference numeral 38 in FIG. 4 indicates a cover tape made of rubber provided around the bundled body of steel wire forming the bead core 16. That is, the bead core 16 is formed by the bundled body of steel wire and the cover tape 38 covering around the bundled body in this example.

In the embodiment, the joining is performed in a state where the temperature difference between the edge part 18A and the root part 18B of the bead filler 18 is equal to or less than 25° C. The joining is performed also in a state where a temperature at the edge part 18A is 39° C. or more.

The bead filler 18 after the extrusion molding is high in temperature, however, it is cooled with time lapse. At that time, the bead filler 18 having the triangular shape in cross section has different thicknesses at the edge part 18A and at the root part 18B. Therefore, reduction speed of temperature differs, and temperature is reduced faster in the edge part 18A with smaller thickness. When the temperature difference between the edge part 18A and the root part 18B is large, difference in rigidity between the both parts is increased when joined to the bead core 16, and the edge part 18A with higher rigidity tends to be deformed so as to bend, namely, tends to be curled. This is because the unvulcanized rubber easily stretches when the temperature is high, whereas it is hard and does not stretch easily when the temperature is low. That is, a force of returning with respect to deformation is low when the temperature is high in the unvulcanized rubber, whereas the force of returning with respect to deformation is high when the temperature is low. When the temperature difference between the edge part 18A and the root part 18B is large in the unvulcanized bead filler 18, rubber does not stretch easily and the force of returning is high in the edge part 18A with a low temperature, therefore, the difference in the force of returning is large with respect to the root part 18B with a high temperature, and curl tends to occur. Accordingly, the unvulcanized bead filler 18 after the extrusion molding that retains heat is joined to the bead core 16 while the temperature difference between the edge part 18A and the root part 18B is small. Accordingly, curl in the bead filler 18 occurring just after fabrication of the bead member 32 can be suppressed.

The temperature of the edge part 18A at the time of joining the bead filler 18 is 39° C. or more as described above, which is joined before the edge part 18A is cooled to be a room temperature. Accordingly, curl can be suppressed by suppressing the rigidity difference between the edge part 18A and the root part 18B at the time of joining, together with the reduction in temperature difference as described above. More preferably, the temperature of the edge part 18A at the time of joining the bead filler 18 is 40° C. or more, and further preferably, the temperature is 43° C. or more to 70° C. or less.

FIG. 5 is a schematic view showing an example of a joining device 52 for joining the bead filler 18 to the bead core 16. The joining device 52 includes a cylindrical rotating drum 54 and a support ring 56 provided on one end side in an axial direction of the rotating drum 54 and having a smaller diameter than that of the rotating drum 54. A plurality of rising pieces 58 are arranged in a lying state on an outer periphery of the rotating drum 54.

When joining the bead filler 18, the bead core 16 is placed on an outer periphery of the support ring 56 as shown in FIG. 5. Then, the strip-shaped bead filler 18 formed by extrusion molding is wound around an outer peripheral surface of the rotating drum 54 in a lying state and end parts in a longitudinal direction are joined to each other to be a cylindrical shape. At this time, the bead filler 18 is in a lying posture so that the bottom surface 18C thereof faces a side surface of the bead core 16.

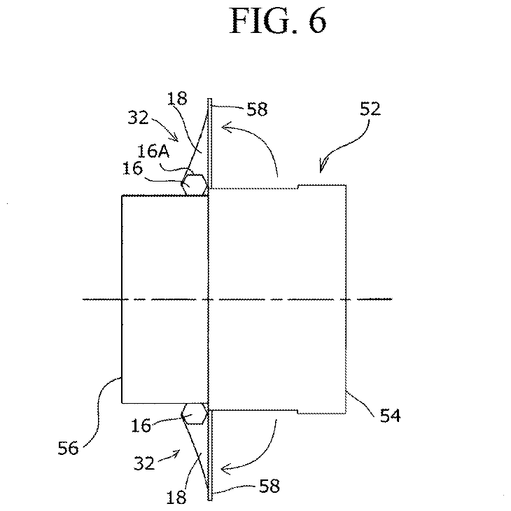

After that, as shown in FIG. 6, the rising pieces 58 are allowed to rise, and the cylindrical bead filler 18 is allowed to rise together to be placed on the outer peripheral surface 16A of the bead core 16. Accordingly, the bottom surface 18C of the bead filler 18 is pressure joined onto the outer peripheral surface 16A of the bead core 16, thereby integrating the bead core 16 with the bead filler 18.

It is also preferable that the cylindrical bead filler is allowed to rise to be joined to the outer peripheral surface of the bead core by using a rotating drum including a bladder as a rubber bag-like member and by expanding the bladder, instead of joining the bead filler 18 by using the mechanical mechanism described above.

Next, the bead cooling process will be explained.

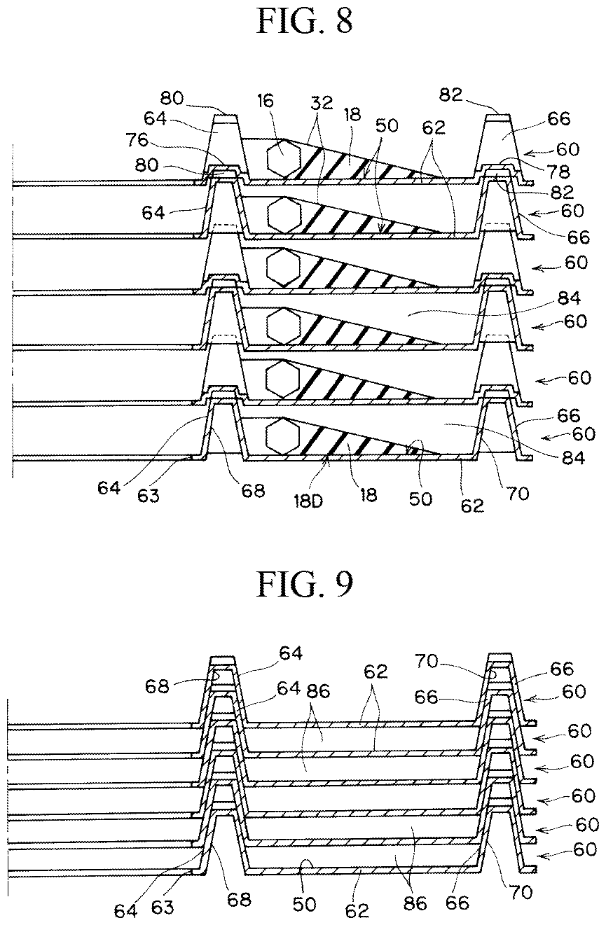

In the bead cooling process, the unvulcanized bead member 32 obtained in the above process is cooled. If the heated bead member 32 obtained in the bead fabrication process is cooled as it is (for example, in a state where the bead filler 18 stands), the edge part 18A of the bead filler 18 curls with time lapse. Accordingly, the bead member 32 is cooled in a state where the side surface 18D of the bead filler 18 is supported on the support surface 50 as shown, for example, in FIG. 8, thereby suppressing curl at the time of cooling.

The bead member 32 may be cooled positively by blowing wind and the like, however, it may be cooled by leaving the bead member 32 as it is in the room temperature. The cooling time is not particularly limited as far as the heat contained in the bead member 32 is removed, and for example, one hour or more as well as three hours or more may be taken.

The support surface 50 is a surface supporting the side surface 18D of the bead filler 18 in the state where the bead member 32 lays down. The bead member 32 is placed on the support surface 50 in a state where the side surface 18D of the bead filler 18 is in surface contact with the horizontal support surface 50.

A material of the support surface 50 is not particularly limited, and the support surface 50 may be made of metal or made of resin. For example, the support surface 50 may be a pan made of metal with a horizontal support surface or a housing holder 60 made of resin as shown in FIG. 7 can be used.

Also in the support surface 50, surface treatment such as formation of fine unevenness may be performed or a hole may be opened on the support surface 50 to reduce a contact area for suppressing sticking of the bead member 32 and making peel-off from the support surface 50 easy.

In the case where the reinforcing tape 36 is stuck to the side surface 18E of the bead filler 18 as described above, it is preferable that cooling is performed by placing the bead filler 18 on the support surface 50 so that the side surface 18D where the reinforcing tape 36 is not provided faces the support surface 50.

Here, the housing holder 60 will be explained. The housing holder 60 is a resin apparatus that can be vertically stacked in a state of housing the bead member 32.

As shown in FIG. 7, the housing holder 60 has a disc-shaped placing part 62 having the support surface 50 that can support the side surface 18D of the bead filler 18. An upper surface of the placing part 62 is the support surface 50. In the center of the placing part 62, a through hole 63 having a smaller diameter than an inner diameter of the bead member 32 is provided. Accordingly, the placing part 62 has a ring-plate shape and the support surface 50 is also formed in a ring shape in this example.

A plurality of convex parts 64, 66 are provided on an inner peripheral side and an outer peripheral side of the placing part 62 in a circumferential direction at fixed intervals. That is, plural convex parts 64 are provided on a circumference at equal intervals on the inner peripheral side of the placing part 62. On the outer peripheral side of the placing part 62, plural convex parts 66 are provided on a circumference at equal intervals. Such convex parts 64, 66 may be provided only on any one side of the outer peripheral side and the inner peripheral side.

As shown in FIG. 8, concave parts 68, 70 are provided on back surface sides of respective convex parts 64, 66. That is, the concave parts 68 are provided on the back sides of respective convex sides 64 and the concave parts 70 are provided on the back sides of respective convex parts 66. The housing holder 60 is formed with an approximately constant wall thickness entirely, therefore, back surface sides of the convex parts 64, 66 are formed in a concave shape to be the concave parts 68, 70. The concave parts 68, 70 are formed so that convex parts 64, 66 of the housing holder 60 to be in a lower stage when plural housing holders 60 are stacked can be fitted thereto as shown in FIG. 9.

As shown in FIG. 7, ring-like parts 72, 74 slightly raised from the placing part 62 are respectively provided on the inner peripheral side and the outer peripheral side of the placing part 62, and the plural convex parts 64, 66 are provided on the ring-shaped parts 72, 74. In the ring-shaped parts 72, 74, first positioning protrusions 76, 78 are provided at the center in the circumferential direction of each region between the plural convex parts 64, 66. On upper surfaces of each of the convex portions 64, 66, second positioning protrusions 80, 82 are provided at the center in the circumferential direction. That is, plural convex parts 64 are provided on the ring-shaped part 72 on the inner peripheral side and the first positioning protrusions 76 are provided on respective regions between the plural convex parts 64, 64. The second positioning protrusions 80 are provided on upper surfaces of respective convex parts 64. Also, plural convex parts 66 are provided in the ring-shaped part 74 on the outer peripheral side, and the first positioning protrusions 78 are provided on respective regions between the plural convex parts 66, 66. The second positioning protrusions 82 are provided on upper surfaces of respective convex parts 66. The first positioning protrusions 76, 78 are ridges extending radially, namely, in radial directions. The second positioning protrusions 80, 82 are also ridges extending radially, namely, in radial directions.

When plural housing holders 60 are stacked, stacking is performed so that the convex parts 64, 66 of the housing holder 60 to be an upper stage and the convex parts 64, 66 of the housing holder 60 to be a lower stage are shifted to one another in the circumferential direction as shown in FIG. 8, gaps 84 that can house the bead members 32 are formed between the placing parts 62, 62 of the housing holders 60, 60 in the upper stage and the lower stage.

At that time, the first positioning protrusions 76, 78 of the housing holder 60 in the upper stage correspond to the second positioning protrusions 80, 82 of the housing holder in the lower stage, and the second positioning protrusions 80, 82 are fitted to concave portions on the back sides of the first positioning protrusions 76, 78. That is, the second positioning protrusions 80 are fitted to the first positioning protrusions 76, and the second positioning protrusions 82 are fitted to the first positioning protrusions 78. Accordingly, the housing holders 60, 60 in the upper stage and the lower stage are stacked in a state of being positioned in the circumferential direction, and the gaps 84 corresponding to heights of the convex parts 64, 66 are formed.

The gap 84 is set to have a height in which the placing part 62 of the housing holder 60 in the upper stage does not abut on the bead member 32 housed below the placing part 62 as shown in FIG. 8. Accordingly, sticking of the placing part 62 of the upper stage onto the bead member 32 and deformation of the bead member 32 can be prevented.

On the other hand, when plural housing holders 60 are stacked, stacking can be performed so that the convex parts 64, 64 and the convex parts 66, 66 of the housing holder 60 to be the upper stage and the housing holder 60 to be the lower stage correspond to one another as shown in FIG. 9, as a result, the convex parts 64, 66 of the housing holder 60 to be the lower stage are respectively fitted into the concave parts 68, 70 of the housing holder 60 to be the upper stage as shown in FIG. 9. Accordingly, gaps 86 between the placing parts 62, 62 in the housing holders 60, 60 of the upper stage and the lower stage become narrow to a degree that the bead member 32 is not capable of being housed. That is, the gap 86 which is narrower than the gap 84 is formed between the placing parts 62, 62 in the housing holders 60, 60 of the upper stage and the lower stage.

When the bead members 32 are cooled by using the housing holders 60, a process in which the bead member 32 is placed on the support surface 50 of the housing holder 60 in the lying state and a process in which the housing holder 60 to be the upper stage is staked above the housing holder 60 in which the bead member 32 is placed in the state in which phases of the convex parts 64, 66 are shifted to one another as described above are repeated. Accordingly, plural housing holders 60 are stacked in the state in which the bead members 32 are housed in respective housing holders 60 as shown in FIG. 8. The bead members 32 are left in the room temperature in the above state to thereby cool the bead members 32.

In such housing holders 60, the convex parts 64, 64 and the convex parts 66, 66 of the upper and lower housing holders 60 are stacked so as to correspond to one another as shown in FIG. 9 when the housing holders 60 are not used for cooling of the bead members 32, thereby narrowing the gaps 86 between the placing parts 62, 62. Accordingly, the housing holders 60 can be stored with saved space when not used.

Next, the green tire forming process will be explained.

In the green tire forming process, the green tire is formed by using the bead member 32 after cooling obtained as described above. As a method of forming the green tire, a well-known method can be adopted and the method is not particularly limited. For example, the green tire may be formed by the following method.

First, as shown in FIG. 10A, the inner liner 30 and the carcass ply 20 are wound around a central part in an axial direction of a forming drum 90, and the side wall rubbers 26 and the rim strips 28 are wound around both end parts in the axial direction. Accordingly, a band body 40 including the inner liner 30, the carcass ply 20, the sidewall rubbers 26 and so on is formed. Next, the bead members 32 are set on outer peripheries at predetermined two places of the band body 40 as shown in FIG. 10B. After that, a portion between the two bead members 32 in the band body 40 is shaped in an outer diameter direction and united with the belt 22 and the tread rubber 24 arranged on an outer diameter side, and further, both end parts of the band body 40 are turned up so as to catch the bead members 32 by using bladders 42, thereby forming the green tire 34 as the unvulcanized tire as shown in FIG. 10C.

After the green tire 34 is formed as described above, vulcanization molding is performed. In vulcanization molding, the green tire 34 is put in a metal mold and held for a predetermined time at a predetermined temperature. After that, the tire is removed from the metal mold, thereby obtaining the pneumatic tire.

According to the embodiment, the bead filler 18 formed by extrusion molding is integrated with the bead core 16 in the state where the temperature difference between the edge part 18A and the root part 18B is small to thereby fabricate the bead member 32. Then, the fabricated bead member 32 is cooled in the state of being placed on the support surface 50 supporting the side surface 18D of the bead filler 18. Therefore, it is possible to suppress curl of the bead filler 18 occurring just after the bead member 32 is fabricated as well as to suppress curl occurring at the time of cooling. The green tire 34 is formed by using the bead member 32 in which curl is suppressed, therefore, forming failure of the pneumatic tire can be suppressed.

The curl can be suppressed also by forming the bead member 32 by joining the bead filler 18 to the bead core 16 after the bead filler 18 is sufficiently cooled. However, both end parts contract when the bead filler extruded in the strip shape is cut with a fixed dimension and cooled to the room temperature, which may deteriorate accuracy of the member. Additionally, time for cooling the bead filler is separately necessary before fabricating the bead member. In the embodiment, the bead filler 18 after the extrusion molding is joined to the bead core 16 in a state of high temperature before cooling, therefore, these problems can be solved.

The housing holders 60 according to the embodiment can be stacked vertically in the state of housing the bead members 32, therefore, plural bead members 32 can be cooled while suppressing the sticking of the placing part 62 in the upper stage onto the bead member 32 and deformation of the bead member 32. The housing holders 60 can be stored with saved space when not used.

As pneumatic tires to be produced in the embodiment, tires for various types of vehicles such as a passenger car tire, heavy load tires for a truck, a bus, light trucks (for example, a SUV vehicle, a pickup truck and so on) can be cited. The present invention is suitable for producing a pneumatic tire for heavy load in which the height of the bead filler is high as one embodiment.

### EXAMPLES

Examples and Comparative Examples specifically showing effects of the embodiment will be explained. The bead members 32 having the cross-sectional view shown in FIG. 4 were fabricated and cooled, then, occurrence of curl was evaluated.

The cross-sectional shape of the bead filler 18 after the extrusion molding is shown in FIG. 2, and the height H of the bead filler 18 is 90 mm, the angle θ of the edge part 18A is 16 degrees.

In the bead fabrication process, the temperature of the bead filler 18 at the time of joining the bead filler 18 was measured at the timing when the bead filler 18 was jointed to the rotating drum 54 and just before allowing the bead filler 18 to rise (see FIG. 5). As a measurement method, an internal temperature was measured by a contact thermometer. A measurement position was a position 10 mm apart from the edge concerning the temperature of the edge part 18A (a sign X1 in FIG. 2) and a position 10 mm apart from an end of the root side concerning the temperature of the root part 18B (a sign X2 in FIG. 2).

In Example 1, the bead filler 18 having heat after the extrusion molding was used, and the bead filler 18 was allowed to rise to be joined to the bead core 16 as shown in FIG. 6 in a state where the temperature at the edge part 18A was 43° C. and the temperature difference between the edge part 18A and the root part 18B was 24° C. After that, the bead members 32 were cooled by being left in room temperature for three hours in the lying state (flat stacking) as shown in FIG. 7 and FIG. 8 by using the housing holder 60 shown in FIG. 7. Occurrence of curl in the bead fillers 18 was checked just after joining and after cooling.

As Example 2 and Comparative Examples 1, 2, the bead members 32 were fabricated and cooled by setting the temperature at the edge part 18A and the temperature difference between the edge part 18A and the root part 18B as written in Table 1 below and by setting other conditions to the same as Example 1.

In Comparative Example 3, the bead members 32 were cooled in a standing state (vertical placing) by supporting inner peripheral surfaces of the bead cores 16 without using the housing holders 60 in the cooling process after fabricating the bead members 32 while setting other conditions to the same as Example 1.

TABLE 1

| | | | Comparative | Comparative | Comparative |
|---|---|---|---|---|---|
| | Example 1 | Example 2 | Example 1 | Example 2 | Example 3 |
| Temperature at edge | 43 | 39 | 23 | 25 | 43 |
| part (° C.) | | | | | |
| Temperature | 14 | 25 | 30 | 14 | 14 |
| difference between | | | | | |
| edge part and root | | | | | |
| part | | | | | |
| Cooling method | Flat stacking | Flat stacking | Flat stacking | Flat itacking | Vertical placin2 |
| Occurrence of curl | Not occur | Not occur | Occurred | Occurred | Not occur |
| just after joining | | | | | |
| Occurrence of curl | Not occur | Not occur | Occurred | Occurred | Occurred |
| after cooling | | | | | |

As shown in Table 1, in Comparative Example 1 in which the temperature difference between the edge part and the root part was large, curl occurred in the bead filler 18 just after joining, and the curl continued even after cooling. In Comparative Example 2, the edge part was cooled to room temperature though the temperature difference between the edge part and the root part was small, therefore, curl occurred in the bead filler 18 just after joining. In Comparative Example 3, curl did not occur in the bead filler 18 just after joining as the temperature difference between the edge part and the root part was small, however, curl occurred at the time of cooling as the bead filler 18 was cooled without supporting the side surface 18D of the bead filler 18 after joining.

On the other hand, in Examples 1, 2 in which the temperature difference between the edge part and the root part was small as well as the temperature of the edge part was high, and further, cooling was performed in flat stacking, curl did not occur in the bead filler 18 just after joining, and curl did not occur even after cooling.

Some embodiments of the present invention have been explained above. These embodiments are cited as examples and do not intend to limit the scope of the invention. These embodiments can be achieved in other various forms and various omissions, replacements and alterations may occur within the scope not departing from the gist of the invention. These embodiments and modifications thereof are contained in the scope and the gist of the invention and contained in inventions described in claims and the range of equivalency.

What is claimed is:

1. A method of producing a pneumatic tire including a bead core embedded in a bead part, and a bead filler arranged on an outer peripheral side of the bead core and having a cross-sectional shape narrowing in width toward an edge, comprising:
fabricating a bead member by integrating the bead filler formed by extrusion molding with the bead core in a state where a temperature difference between an edge part and a root part of the bead filler is 25° C. or less as well as a temperature at the edge part is 39° C. or more;
cooling the bead member by being placed on a support surface supporting a side surface of the bead filler; and
forming a green tire using the cooled bead member.

2. The method of producing the pneumatic tire according to claim 1,
wherein a height of the bead filler formed by extrusion molding is 80 mm or more.

3. The method of producing the pneumatic tire according to claim 1,
wherein an angle at the edge part of the bead filler formed by extrusion molding is 16.0 degrees or less.

4. The method of producing the pneumatic tire according to claim 1,
wherein, in the step of cooling the bead member, a housing holder capable of being stacked vertically in a state of housing the bead member is used,
the housing holder includes a disc-shaped placing part having the support surface, convex parts provided on at least one of circumferences on an inner peripheral side or an outer peripheral side of the placing part, and concave parts provided on back surface sides of the convex parts, to which convex parts of a housing holder to be a lower stage are capable of being fitted at the time of stacking the housing holders, wherein a gap capable of housing the bead member is formed between placing parts of housing holders of an upper stage and a lower stage by stacking housing holders so that the convex parts of the housing holder to be the upper stage and the convex parts of the housing holder to be the lower stage are shifted to one another in a circumferential direction, and a gap which is narrower than the gap capable of housing the bead member is formed between placing parts of the housing holders of the upper stage and the lower stage by stacking the housing holders in a state where the convex parts are fitted to the concave parts so that the convex parts of the housing holder to be the upper stage and the convex parts of the housing holder to be the lower stage correspond to one another, and
cooling is performed in a state where the bead member is housed in the gap formed by stacking the housing holders so that the convex parts are shifted to one another in the step of cooling the bead member.

5. The method of producing the pneumatic tire according to claim 2,
wherein, in the step of cooling the bead member, a housing holder capable of being stacked vertically in a state of housing the bead member is used,
the housing holder includes a disc-shaped placing part having the support surface, convex parts provided on at least one of circumferences on an inner peripheral side or an outer peripheral side of the placing part, and concave parts provided on back surface sides of the convex parts, to which convex parts of a housing holder to be a lower stage are capable of being fitted at the time of stacking the housing holders, wherein a gap capable of housing the bead member is formed between placing parts of housing holders of an upper stage and a lower stage by stacking housing holders so that the convex parts of the housing holder to be the upper stage and the convex parts of the housing holder to be the lower stage are shifted to one another in a circumferential direction, and a gap which is narrower than the gap capable of housing the bead member is formed between placing parts of the housing holders of the upper stage and the lower stage by stacking the housing holders in a state where the convex parts are fitted to the concave parts so that the convex parts of the housing holder to be the upper stage and the convex parts of the housing holder to be the lower stage correspond to one another, and
cooling is performed in a state where the bead member is housed in the gap formed by stacking the housing holders so that the convex parts are shifted to one another in the step of cooling the bead member.

6. The method of producing the pneumatic tire according to claim 3,
wherein, in the step of cooling the bead member, a housing holder capable of being stacked vertically in a state of housing the bead member is used,
the housing holder includes a disc-shaped placing part having the support surface, convex parts provided on at least one of circumferences on an inner peripheral side or an outer peripheral side of the placing part, and concave parts provided on back surface sides of the convex parts, to which convex parts of a housing holder to be a lower stage are capable of being fitted at the time of stacking the housing holders, wherein a gap capable of housing the bead member is formed between placing parts of housing holders of an upper stage and a lower stage by stacking housing holders so that the convex parts of the housing holder to be the upper stage and the convex parts of the housing holder to be the lower stage are shifted to one another in a circumferential direction, and a gap which is narrower than the gap capable of housing the bead member is formed between placing parts of the housing holders of the upper stage and the lower stage by stacking the housing holders in a state where the convex parts are fitted to the concave parts so that the convex parts of the housing holder to be the upper stage and the convex parts of the housing holder to be the lower stage correspond to one another, and
cooling is performed in a state where the bead member is housed in the gap formed by stacking the housing holders so that the convex parts are shifted to one another in the step of cooling the bead member.

7. The method of producing the pneumatic tire according to claim 1, further comprising the step of:
performing vulcanization molding of the green tire.

8. A housing holder for a bead member capable of being stacked vertically in a state of housing the bead member including a bead core and a bead filler integrated with the bead core on an outer peripheral side, comprising:
a disc-shaped placing part having a support surface capable of supporting a side surface of the bead filler;
convex parts provided on at least one of circumferences on an inner peripheral side or an outer peripheral side of the placing part; and
concave parts provided on back surface sides of the convex parts, to which convex parts of a housing holder to be a lower stage are capable of being fitted at the time of stacking the housing holders,
wherein a gap capable of housing the bead member is formed between placing parts of housing holders of an upper stage and a lower stage by stacking housing holders so that the convex parts of the housing holder to be the upper stage and the convex parts of the housing holder to be the lower stage are shifted to one another in a circumferential direction, and a gap which is narrower than the gap capable of housing the bead member is formed between placing parts of the housing holders of the upper stage and the lower stage by stacking the housing holders in a state where the convex parts are fitted to the concave parts so that the convex parts of the housing holder to be the upper stage and the convex parts of the housing holder to be the lower stage correspond to one another.
